(19) United States
(12) Patent Application Publication
(10) Pub. No.: US 2011/0182134 A1
(43) Pub. Date: Jul. 28, 2011

(54) MIXING SYSTEM COMPRISING AN EXTENSIONAL FLOW MIXER

(75) Inventors: Maria Pollard, Pearland, TX (US); Steven R. Strand, Midland, MI (US); David A. Eversdyk, Angleton, TX (US); Matthias Schaefer, Lake Jackson, TX (US)

(73) Assignee: Dow Global Technologies Inc., Midland, MI (US)

(21) Appl. No.: 12/692,009

(22) Filed: Jan. 22, 2010

(51) Int. Cl. B01F 5/06

(52) U.S. Cl. 366/172.2

(57) ABSTRACT

A mixing system is disclosed comprising at least one extensional flow mixer comprising:
a generally open and hollow body having a contoured outer surface and having:
   a single entrance port and a single exit port;
   a means for compressing a bulk stream flowing through the generally open and hollow body in a direction of flow and at least one injected additive stream introduced at the single entrance port in the direction of flow; and
   a means for broadening the bulk stream and the at least one injected additive stream such that an interfacial area between the bulk stream and the at least one injected additive stream is increased as the bulk stream and the at least one injected additive stream flow through the generally open and hollow body in the direction of flow to promote mixing of the bulk stream and the at least one injected additive stream,
   a flow conductor having an axis and having a generally open and hollow flow mixer body secured therein; and
   a primary additive stream injector positioned at the entrance port of the generally open and hollow flow mixer body, wherein the primary additive stream injector injects an additive stream into the interior of the flow mixer in the direction of flow when the bulk stream is flowing through the generally open and hollow flow mixer body to allow compression and broadening of the bulk stream and the additive stream together to facilitate mixing of the bulk stream and the primary additive stream at an exit of the extensional flow mixer,
   wherein the extensional flow mixer is followed by at least one of helical static mixing elements that is at least one half flow conductor diameter downstream of the exit of the extensional flow mixer.

### BACKGROUND OF THE INVENTION

The present invention relates generally to static mixers, and more particularly, to an extensional flow mixer followed by helical type mixing elements, preferably also followed by of high-shear, high-pressure drop static mixing elements, that mixes two or more fluid streams flowing in a pipe.

It is often desirable to mix fluids having varied viscosities in a pipe. In a turbulent flow, mixing occurs more quickly due to induced turbulence. In a laminar flow, mixing of fluid streams is more difficult. In solution polymerization, for example, it is often desirable to mix a relatively high viscosity bulk stream, such as a polymer solution, with a relatively low viscosity liquid additive stream. Liquid additives, catalysts, liquid monomers and solvents are typically added to polymer solution to achieve other polymer products.

However, because of the high shear forces necessary to promote mixing, the high viscosity bulk stream and the low viscosity additive stream may remain essentially segregated, resulting in low rates of additive stream incorporation into the bulk stream. In a laminar flow, mixing occurs by diffusion of one stream into another, which typically is a slow process. The slow diffusion is unacceptable when a quicker mixing time is necessary for dispersion. Frequently, when the additive stream is injected into the bulk stream, the additive stream will remain substantially intact and tunnel through the bulk stream without significant interfacial mixing of the streams. This low mixing rate is due in part to the low surface area contact between the bulk stream and the additive stream. To combat such a result, it is advantageous to deform the additive stream from the cylindrical shape the additive stream initially has, to a relatively flat sheet having more surface area. It is found that deforming the additive stream by increasing its aspect ratio, the ratio of its width to its height, increases its surface area and therefore its potential interfacial mixing area. The increase in surface area also facilitates the strategy of cutting, dividing and recombining the streams in traditional static mixers. The distribution of the additive stream as a thin sheet also increases the mixing efficiency of the static mixing elements, if any, following the extensional flow mixer.

Several types of structures are known to promote mixing of a bulk stream with an additive stream, including baffle structures and shear mixers. U.S. Pat. No. 4,808,007, issued to King, discloses a dual viscosity mixer which introduces an additive stream to a bulk stream through an entry port within the mixer to create an elongated flat plane of the additive stream.

Several problems have been encountered in the field with this and other mixing structures, however. For example, in polymerization applications, polymer build-up has been observed at the contact points between the additive stream injector and the bulk stream polymer. This build-up often occurs when the additive stream is injected from within the static mixer. The polymer build-up problem compounds itself until eventually there is plugging or complete closure of the additive injector, leading to flow maldistribution in the static mixer.

Additionally, when an additive stream, such as a catalyst, contacts a baffle or other solid contact surface or wall, a wetting of the surface with the catalyst occurs, thereby decreasing the overall mixing efficiency of the catalyst with the bulk stream.

In those mixers where there are severe angular regions or step-like features, the bulk stream and the additive stream, while flowing out of such features, may develop recirculation zones and eddy currents, which decreases the overall mixing efficiency of the mixer.

Another problem is the loss of fluid pressure as the streams pass the mixer. Other dual viscosity mixers available have a relatively high pressure drop, as the streams lose fluid pressure between entering and exiting the mixer.

While the prior art discloses static mixers that mix bulk streams with additive streams, there exists a need for an extensional flow mixer that maximizes the mixing of the bulk stream and the additive stream by increasing the interfacial area between the streams, while minimizing the polymer plugging, catalyst build-up, pressure loss, flow maldistribution and fouling problems associated therewith not solved by the prior art.

### SUMMARY OF THE INVENTION

The present invention provides a mixing system comprising at least one extensional flow mixer comprising:

a generally open and hollow body having a contoured outer surface and having:

a single entrance port and a single exit port;

a means for compressing a bulk stream flowing through the generally open and hollow body in a direction of flow and at least one injected additive stream introduced at the single entrance port in the direction of flow; and

a means for broadening the bulk stream and the at least one injected additive stream such that an interfacial area between the bulk stream and the at least one injected additive stream is increased as the bulk stream and the at least one injected additive stream flow through the generally open and hollow body in the direction of flow to promote mixing of the bulk stream and the at least one injected additive stream,

a flow conductor having an axis and having a generally open and hollow flow mixer body secured therein; and

a primary additive stream injector positioned at the entrance port of the generally open and hollow flow mixer body, wherein the primary additive stream injector injects an additive stream into the interior of the flow mixer in the direction of flow when the bulk stream is flowing through the generally open and hollow flow mixer body to allow compression and broadening of the bulk stream and the additive stream together to facilitate mixing of the bulk stream and the primary additive stream at an exit of the extensional flow mixer.

Wherein, the extensional flow mixer is followed by at least one of helical static mixing elements that is at least one half flow conductor diameter downstream of the exit of the extensional flow mixer.

Preferably, in the mixing system, the means for compressing and the means for broadening each includes a plurality of contoured lobes, each lobe having a substantially contoured surface and wherein the plurality of contoured lobes in the means for compressing decrease in size in the direction of flow and the plurality of contoured lobes in the means for broadening increase in size in the direction of flow.

Also preferably, in the mixing system, the means for compressing lie in a compression plane and the means for broadening lie in a broadening plane perpendicular to the compression plane.

Also preferably, in the mixing system, the means for compressing decreases in size along the compression plane in the direction of flow and the means for broadening simultaneously increases in size along the broadening plane in the direction of flow.

Also preferably, in the mixing system, the helical mixing element is not more than four flow conductor diameters downstream.

Also preferably, the mixing system further comprises at least one of high-shear, high-pressure drop static mixing elements comprising an array of crossed bars arranged at an angle of 45° against the axis and arranged in such a way, that consecutive elements are rotated by 90° around the axis, placed downstream of the helical mixing elements.

Also preferably, in the mixing system, the primary additive stream injector is positioned at a center of the entrance port.

Also preferably, in the mixing system, the primary additive stream injector is positioned along a longitudinal axis of the generally hollow flow mixer body, especially wherein the additive stream injector is further positioned at a center of the single entrance port.

Also preferably, in the mixing system, the bulk stream received by the single entrance port includes at least one of a polymer and a polymer solution.

Also preferably, in the mixing system, the additive stream received by the single entrance port includes at least one of a monomer and a monomer solution, more preferably wherein the monomer solution is ethylene dissolved in solvent.

Also preferably, in the mixing system, the additive stream received by the single entrance port includes at least one of an additive or additive in solution, especially wherein the additive stream received by the single entrance port is selected from a group consisting of antioxidants, acid scavengers, catalyst kill agents and solutions thereof.

Also preferably, in the mixing system, the lobes of the compression region meet at a constricted central entrance portion and the lobes of the broadening region meet at a constricted central exit portion.

Also preferably, in the mixing system, the exit of the extensional flow mixer is perpendicular to a leading edge of the helical type mixing element.

Various other features, objects and advantages of the present invention will be made apparent from the following detailed description and the drawings.

The drawings illustrate a preferred mode presently contemplated for carrying out the invention.

### BRIEF DESCRIPTION OF THE DRAWINGS

FIG. 1 is a perspective view of one embodiment of the extensional flow mixer of the present invention with a single additive stream injector;

FIG. 2 is a frontal view of the extensional flow mixer, looking downstream and showing the extensional flow mixer secured within a portion of the flow conductor, taken along line 2-2 of FIG. 1;

FIG. 3 is a rear view of the extensional flow mixer of FIG. 2 looking upstream;

FIG. 4 is a side view of the extensional flow mixer in accordance with the present invention secured within the sectioned flow conductor;

FIG. 5 is a side sectional view of the extensional flow mixer showing the compression region in accordance with the present invention, taken along line 5-5 of FIG. 1;

FIG. 6 is a top sectional view of the extensional flow mixer showing the broadening region in accordance with the present invention, taken along line 6-6 of FIG. 1;

FIG. 7 is a perspective view showing the primary additive stream injector, plus a preferred location of two additional additive injection streams directed to the exterior of the extensional flow mixer in accordance with one aspect of the invention;

FIG. 8 is a frontal view showing the primary additive stream injector, plus a preferred position of the two additional additive stream injectors in accordance with one aspect of the invention, taken along line 8-8 of FIG. 7; and

FIG. 9 is a perspective view of a three lobe per region embodiment of the present invention with the primary additive stream injector;

FIG. 10 is a frontal view of the three lobe per region embodiment of the present invention looking downstream, taken along line 10-10 of FIG. 9;

FIG. 11 is a rear view of the three lobe per region embodiment of FIG. 9 looking upstream;

FIG. 12 is a side view of the three lobe embodiment of the present invention in FIG. 9;

FIG. 13 is a plan view showing the three lobe per region embodiment of the present invention, taken 60 degrees above FIG. 12;

FIG. 14 is a perspective view of the three lobe per region embodiment of the present invention with the primary additive stream injector and the preferred locations of the additional additive stream injectors;

FIG. 15 is a frontal view of the three lobe per region embodiment of the present invention looking downstream, taken along line 15-15 of FIG. 14;

FIG. 16 is a perspective view of a four lobe per region embodiment of the present invention with the primary additive stream injector;

FIG. 17 is a frontal view of the four lobe per region embodiment of the present invention looking downstream, taken along line 17-17 of FIG. 16;

FIG. 18 is a rear view of the four lobe per region embodiment of FIG. 16 looking upstream;

FIG. 19 is a side view of the four lobe per region embodiment of the present invention in FIG. 16;

FIG. 20 is a plan view showing the four lobe per region embodiment of the present invention, taken 45 degrees above FIG. 19;

FIG. 21 is a perspective view of the four lobe per region embodiment of the present invention with the primary additive stream injector and the preferred locations of the additional additive stream injectors; and

FIG. 22 is a frontal view of the four lobe per region embodiment of the present invention looking downstream, taken along line 22-22 of FIG. 21.

FIG. 23 is of statistical analysis of acid concentration in the vapor space of a vessel in parts per million volume for the invention and a comparison.

FIG. 24 is simulated coefficient of variance for the invention and a comparison.

FIG. 25 is simulated coefficient of variance for profiles along the conductor length for the inventions and a base comparison.

FIGS. 26 (a), (b), and (c) are simulated coefficient of variance for profiles along the conductor length for the invention and a base comparison.

FIGS. 27 (a) and (b) are simulated coefficient of variance for profiles along the conductor length for the inventions.

FIGS. 28 (a), (b), and (c) are photographs of blends of resins where the secondary stream is black and the primary stream is white along the axis of the conductor at the end of the mixing system for the inventions and a base comparison.

### DETAILED DESCRIPTION OF THE INVENTION

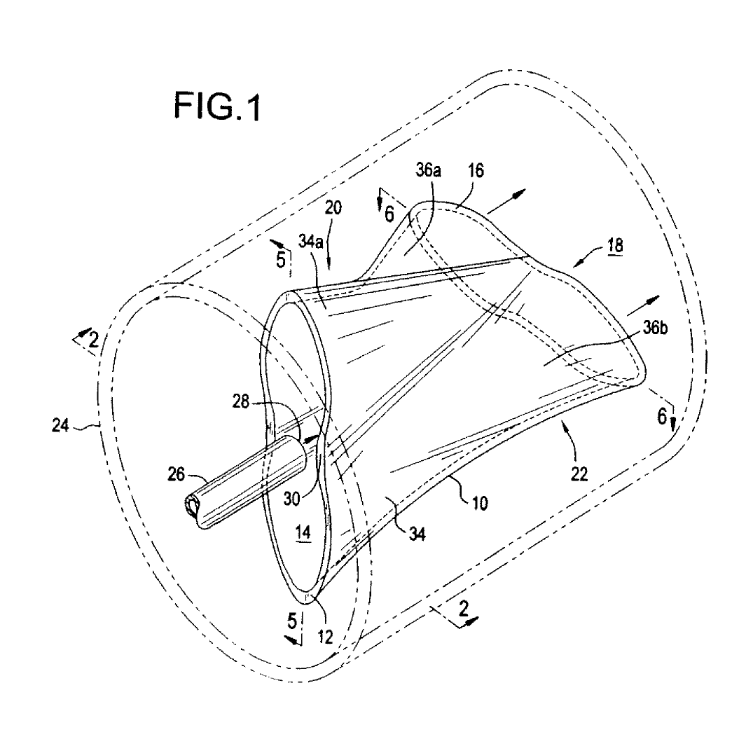

Referring to FIG. 1, a flow mixer 10 is shown. Flow mixer 10 has a generally open and hollow-shaped body, which terminates at one end at an edge 12 which defines the outer perimeter of an entrance port 14. Flow mixer 10 terminates at a distal end at an edge 16, shown in phantom, which defines the perimeter of the exit port 18. Flow mixer 10 includes a compression region 20 and a broadening region 22. In the embodiment shown, the compression region is made up of two compression region lobes 34a and 34b, and the broadening region is made up of two broadening region lobes 36a and 36b. The compression region 20 lies in a compression plane that includes line 5-5 and a longitudinal axis extending from the entrance port 14 to the exit port 18. The broadening region 22 lies in a broadening plane that includes line 6-6 and is coaxial with the compression plane of the compression region 20 by sharing the longitudinal axis with the compression plane. Preferably, the compression plane of the compression region 20 is perpendicular to the broadening plane of the broadening region 22. As a result, the compression region lobes 34a and 34b are preferably positioned 90 degrees from the position of the broadening region lobes 36a and 36b. Flow mixer 10 has a generally contoured shape that can be achieved by, for example, deforming a cylinder by constricting one end of the cylinder, rotating the cylinder 90 degrees, and then constricting the other end in a similar manner.

Typically, the flow mixer 10 resides within a flow conductor 24, for example, a pipe, shown in phantom. Flow conductor 24 conducts a bulk stream, typically of a high viscosity under laminar flow conditions. The flow mixer 10 is useful, however, at a wide range of pipe Reynolds numbers. In polymerization applications, the flow conductor 24 will conduct a polymer solution as the bulk stream. Particular polymers may include any of a number of copolymers of ethylene and 1-octene, 1-hexene, 1-butene, 4-methyl-1-pentene, styrene, propylene, 1-pentene or alpha-olefin. The flow conductor 24 introduces the bulk stream to the flow mixer 10 in a direction of flow from the entrance port 14 to the exit port 18.

It is contemplated that the utilization of the present invention in solution polymerization applications could be effected in a single loop or dual loop reactor (not shown). A suitable reactor is disclosed in PCT Application, International Publication Number WO 97/36942, entitled “Olefin Solution Polymerization”, filed on Apr. 1, 1997; and U.S. Provisional Applications 60/014,696 and 60/014,705, both filed on Apr. 1, 1996.

Also residing within the flow conductor 24 is a primary additive stream injector 26. The primary additive stream injector 26 is responsible for carrying an additive stream that is to be mixed with the bulk stream carried by the flow conductor 24. Typically, the additive stream is of a low viscosity and is not easily mixed. It is contemplated that many types of additives may be used. Particularly, the additive stream may include catalyst solutions, monomers, gases dissolved in solvent, antioxidants, UV stabilizers, thermal stabilizers, waxes, color dyes and pigments.

Suitable polymers, catalysts and additives contemplated by the present invention include those disclosed in U.S. Pat. No. 5,272,236; U.S. Pat. No. 5,278,272; and U.S. Pat. No. 5,665,800, all issued to Lai et al., and entitled “Elastic Substantially Linear Olefin Polymers”; and U.S. Pat. No. 5,677,383, issued to Chum et al., entitled “Fabricated Articles Made From Ethylene Polymer Blends.”

In the polymerization process, the additive stream may be a catalyst solution or a monomer, such as ethylene dissolved in solvent, which is injected through an outlet 28 of the primary additive stream injector 26 positioned at the entrance port 14. In the embodiment shown, the single additive stream injector 26 is positioned such that its additive stream injector outlet 28 is flush with the plane of the entrance port 14 and aimed at the middle of the entrance port 14. The primary additive stream injector 26 injects the additive stream in the direction of flow without having any physical contact with the flow mixer 10. The primary additive injector 26 can be of many designs other than the tube shown, as long as it is capable of accurately delivering an additive stream.

The diameter of the additive stream injector outlet 28 should be large enough that plugging due to impurities is avoided, but preferably small enough so that the exit velocity of the stream from the primary additive stream injector 26, (that is, the jet exit velocity) is greater than or equal to the average bulk stream velocity.

Compression region 20 decreases in size along the compression plane in the direction of flow as the broadening region 22 simultaneously increases in size along the broadening plane in the direction of flow. It is the simultaneous compression and broadening of the additive stream that increases the interfacial area between the bulk stream and the additive stream, thus promoting the mixing of the additive stream and the bulk stream as they are channeled through the flow mixer 10.

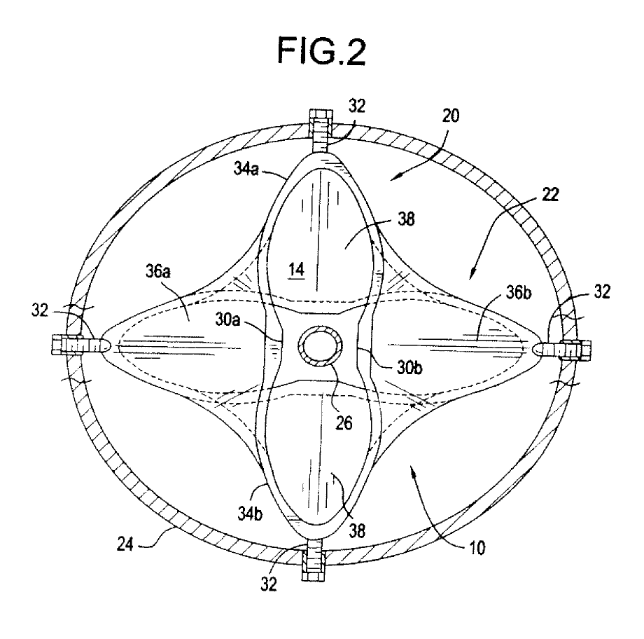

Referring to FIG. 2, the flow mixer 10 is shown looking downstream in the direction of flow. The flow mixer 10 is suspended and secured within the flow conductor 24 in a symmetrical fashion about the center of the flow conductor 24 by any practical method. In the embodiment shown, the flow mixer 10 is secured by struts 32, such that the flow mixer 10 is substantially stable to be able to withstand the fluid pressure of the bulk stream against the flow mixer 10. The struts 32 are not required, however, as the flow mixer 10 could be glued, welded or otherwise attached to the flow conductor 24.

The primary additive stream injector 26 is preferably oriented along the longitudinal axis of the flow mixer 10 and at the center of the entrance port 14 at a midpoint of constricted central entrance portions 30a and 30b. The placement of the primary additive stream injector 26 at the center of the entrance port 14 minimizes the downstream obstructions for the additive stream. The minimization of obstructions also reduces the pressure losses of the streams as they flow through the generally open and hollow body of the flow mixer 10.

The compression region 20 and the broadening region 22 are each comprised of a pair of lobe-shaped structures 34a, 34b and 36a, 36b, respectively. The size of the compression region lobes 34a and 34b is greatest at the entrance port 14 and generally decrease in size along the compression region 20 in the direction of flow. The broadening region lobes 36a and 36b, in contrast, are at a minimum at the entrance port 14 and generally increase along the broadening region 22 in the direction of flow.

The primary additive stream injector 26 is positioned at the entrance port 14 such that there is no obstacle to the additive stream when injected. The bulk stream flowing in flow conductor 24 and the additive stream injected by the additive stream injector 26 are channeled along the interior surface 38 of the compression region lobes 34a and 34b to become narrower in the compression region 20. The size of the lobes 34a and 34b of the compression region 20 should be the same to promote uniform compression of the streams. The compression region lobes 34 meet at the central constricted entrance portions 30a and 30b.

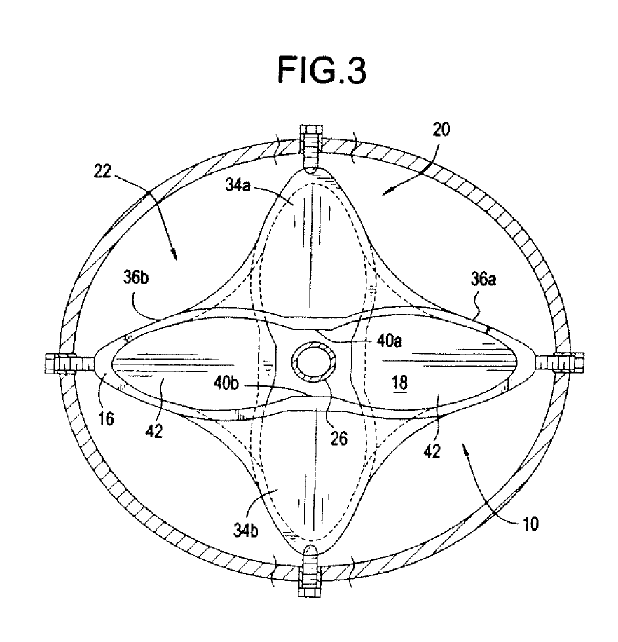

Referring now to FIG. 3, the flow mixer 10 is shown looking upstream against the direction of flow and facing the primary additive stream injector 26. The broadening region lobes 36 meet at a central constricted exit portions 40a and 40b of the exit port 18. The bulk stream and the additive stream are channeled from the compression region lobes 34a and 34b of the compression region 20 along the interior surface 42 of the broadening region lobes 36a and 36b until the bulk stream and the additive stream reach their maximum deformation at the exit port 18. The flow patterns of the streams making the sudden but continuous transition from the compression region 20 to the broadening region 22 is sufficient to enhance the mixing of the bulk stream and the additive stream by deforming the additive stream, creating additional surface area.

The size of the exit port 18 is preferably that of the entrance port 14, but the exit port 18 should not be smaller than the entrance port 14 to avoid flow reversal inside the flow mixer 10. Additionally, the size and shape of the lobes 36a and 36b of the broadening region 22 should be the same to promote uniform broadening of the streams.

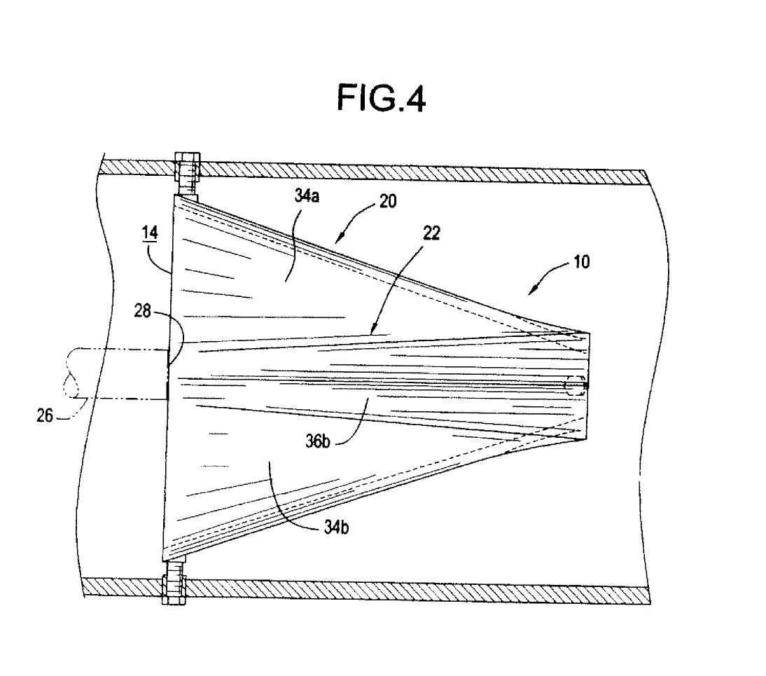

Referring to FIG. 4, a side view of the flow mixer 10 is shown. The compression region 20 and the broadening region 22 are integrally formed. The flow mixer 10 is preferably constructed from a single piece of material. Any material that is suitable for the particular construction is contemplated by the present invention. Preferably, a material that is capable of being deformed into the compression region 20 and the broadening region 22, such as metal or polyvinyl chloride (PVC), is contemplated. The length of the flow mixer 10 is variable, although preferably it approximates the width of the flow mixer 10 at its widest point.

The primary additive stream injector 26, shown in phantom, is positioned along a longitudinal axis of the flow mixer 10. For maximum mixing enhancement, the additive stream injector 26 is preferably placed at the center, directed along the central longitudinal axis. The additive stream injector 26 is also preferably positioned such that there is no direct contact between the additive stream injector 26 and the flow mixer 10. Although the additive stream injector 26 is preferably positioned flush with the plane of the entrance port 14, the additive stream injector outlet 28 could also be mounted outside the plane of the entrance port 14, preferably by a small distance so that the additive stream will enter into the center of the flow mixer 10.

There is a continuity from the lobes 34a and 34b of the compression region 20 to the lobes 34a (not shown) and 34b of the broadening region 22 to reduce the likelihood of sharp angles and corner regions, which may cause bulk stream or additive stream build-up along the flow mixer 10. The generally hollow shape and the lack of sharp interior corners reduce the pressure losses of the bulk stream and the additive stream as they flow through the flow mixer 10.

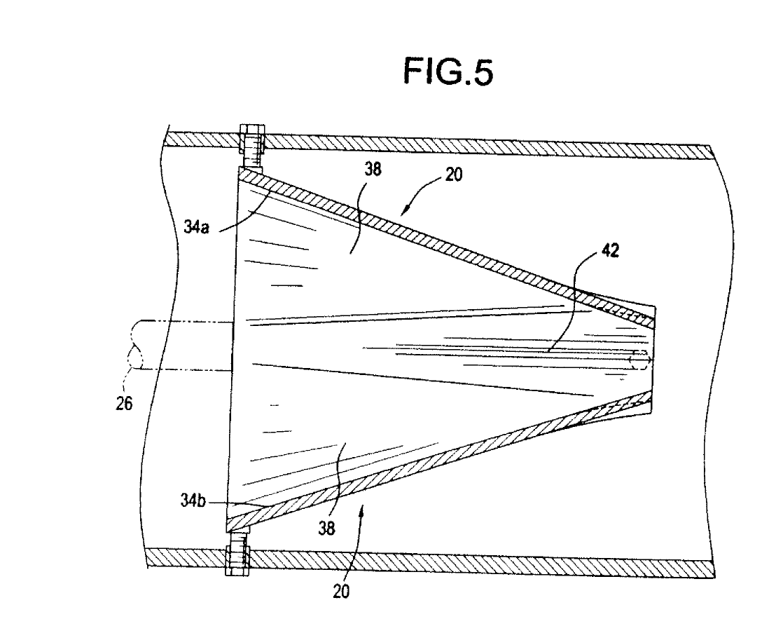

Referring to FIG. 5, the compression region 20 preferably has a generally triangular shape along the compression plane. The compression region 20 decreases in the direction of flow, such that any fluid streams entering the flow mixer 10 will be narrowed in the direction of flow and channeled along the interior surface 38 of the compression region lobes 34a and 34b towards the path of the injected additive stream coming from the primary additive stream injector 26.

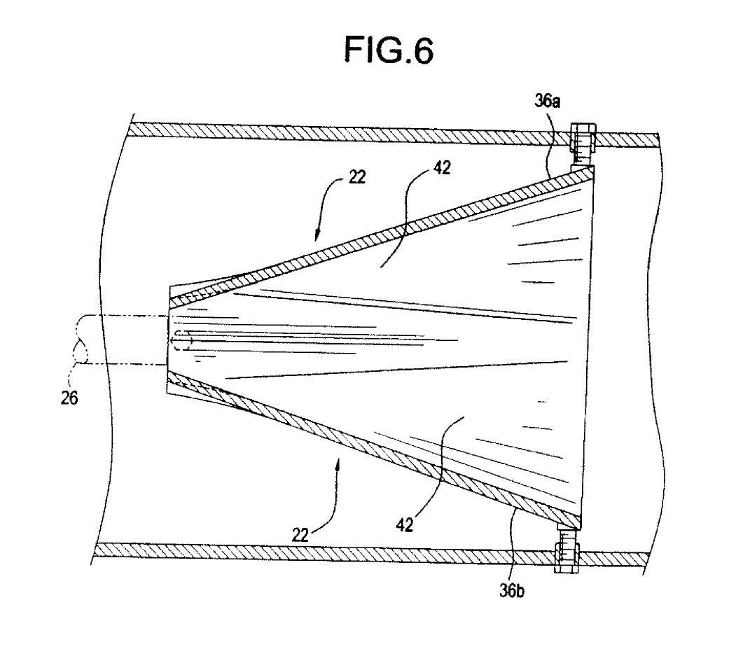

Referring to FIG. 6, the broadening region 22 is also preferably generally triangular in shape along the broadening plane. The broadening region 22 increases in the direction of flow. Fluid within the broadening region 22 will be channeled along the interior surface 42 of the broadening region lobes 36a and 36b. This results in a widening of the flow within the broadening region 22. Consequently, the surface area of the additive stream from primary stream additive injector 26 is increased, thereby increasing its potential interfacial mixing area with the bulk stream.

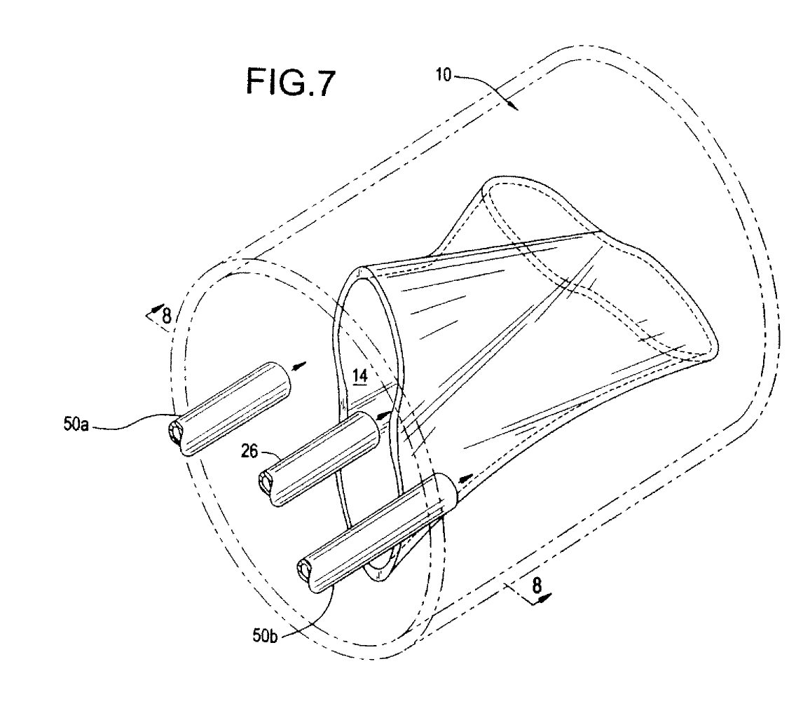

Referring now to FIG. 7, another embodiment of the flow mixing system is shown. In this embodiment, the bulk stream continues to flow through and around the generally open and hollow flow mixer 10. In addition to the primary additive stream injector 26 positioned at the entrance port 14, a pair of additional additive stream injectors 50a and 50b are preferably positioned flush with the plane of the entrance port 14 and aimed along the exterior of the generally open and hollow flow mixer 10. The additional additive stream injectors 50a and 50b may inject different additive streams than those injected by the primary additive stream injector 26. Preferably, the additive stream injectors 50a and 50b are positioned on either side of the primary additive stream 26. It is also contemplated that one or both of the additional additive stream injectors 50a and 50b could be used separately, or each in combination with the primary additive stream injector 26, depending on the number and type of additive streams to be incorporated into the bulk stream. A single additional additive stream injector may be used.

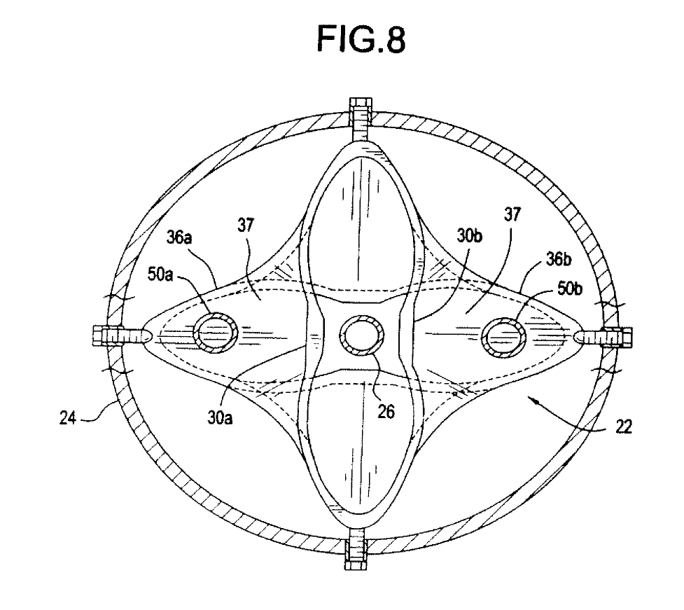

Referring to FIG. 8, the additional additive stream injectors 50a and 50b are preferably placed midway between the constricted central entrance portions 30a and 30b and the flow conductor 24, such that the additive stream injectors 126a and 126b are oriented to inject their respective additive streams into the exterior region 37 of the broadening region 22. Each additive stream injected from the additive stream injectors 126a and 126b will then deform in the exterior region 37 of the broadening region 22, causing the interfacial area between each additive stream and the bulk stream to increase, and promote the mixing of the bulk stream and the additive streams. Preferably, the additional additive stream injectors 50a and 50b inject their respective additive streams simultaneously. The additive stream injectors 50a and 50b can be positioned further from or closer to the flow mixer 10. Additional injection points may be, for example, one-third and two-thirds the distance from the central constricted entrance portions 30a and 30b to the flow conductor 24 on either side of the primary additive stream injector 26 and directed along the exterior 37 of the flow mixer 10.

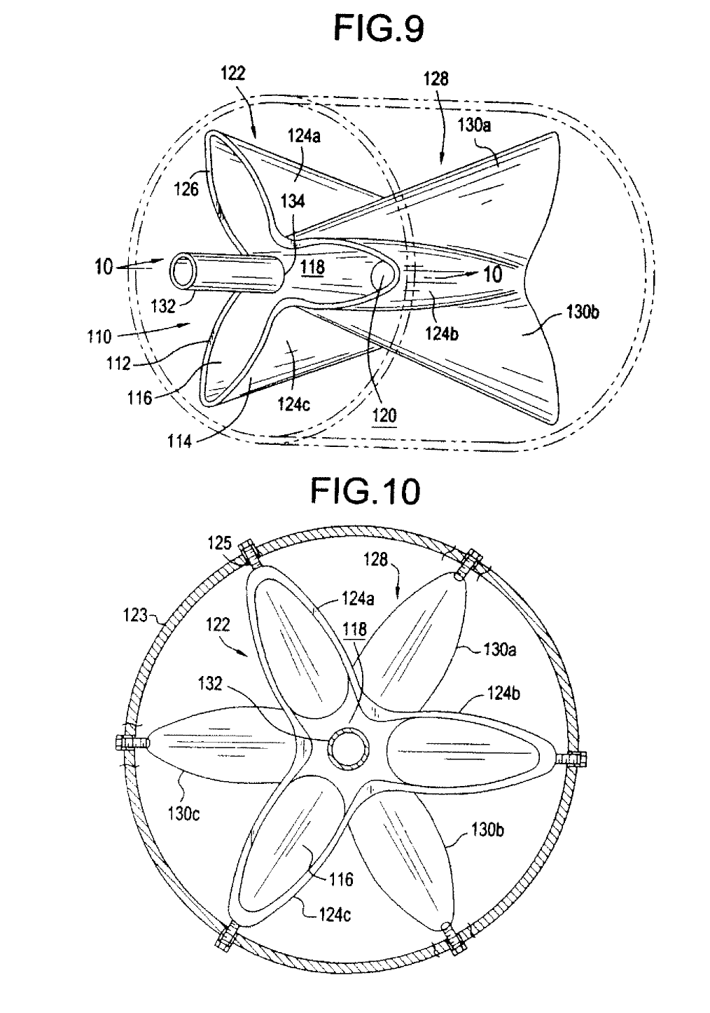

Referring now to FIG. 9, another embodiment of the present invention is shown. An extensional flow mixer, shown generally by the reference numeral 110, includes a generally open and hollow flow mixer body 112. The generally open and hollow flow mixer body 112 has a contoured outer surface 114 and a contoured inner surface 116 which follows the shape of the contoured outer surface 114.

The extensional flow mixer 110 includes a single entrance port 118 and a single exit port 120. A direction of flow is defined in moving from the single entrance port 118 to the single exit port 120. A leading edge 126 forms the outline of the single entrance port 118.

The generally open and hollow flow mixer body 112 includes a compression region 122. The compression region 122 includes contoured lobes 124a, 124b, and 124c. The contoured lobes 124a, 124b and 124c of the compression region 122 decrease in size in the direction of flow from the leading edge 126 of the single entrance port 118 to the single exit port 120. The generally open and hollow flow mixer body 112 also includes a broadening region 128. The broadening region 128 similarly includes contoured lobes 130a, 130b and 130c (not shown). The contoured lobes 130a, 130b and 130c in the broadening region 128 increase in size in the direction of flow when going from the single entrance port 118 to the single exit port 120. The contoured lobes 124a, 124b and 124c of the compression region 122 alternate with the contoured lobes 130a, 130b and 130c of the broadening region 128 around the contoured outer surface 114 of the generally open and hollow flow mixer body 112.

A primary additive stream injector 132 is positioned at the single entrance port 118 such that the outlet 134 of the primary additive stream injector 132 is positioned at the center of and flush with the single entrance port 118.

Referring now to FIG. 10, the size and shape of the contoured lobes 124a, 124b and 124c of the compression region 122 are preferably the same as the size and shape of the contoured lobes 130a, 130b and 130c of the broadening region 128.

The primary additive stream injector 132 is preferably positioned so as to inject a primary additive stream through the interior of the generally open and hollow flow mixer body 112 without encountering any obstacles.

In operation, the bulk stream flowing through the generally open and hollow flow mixer body 112 will compress in the compression region 122 and thereby compress the primary additive stream and increase its interfacial mixing area.

The bulk stream enters the single entrance port 118 and is compressed by the contoured inner surface 116 of each of the contoured lobes.

The extensional flow mixer 110 is attached to a flow conductor 123, typically a cylinder, preferably by way of struts 125, although any suitable attachment method is acceptable.

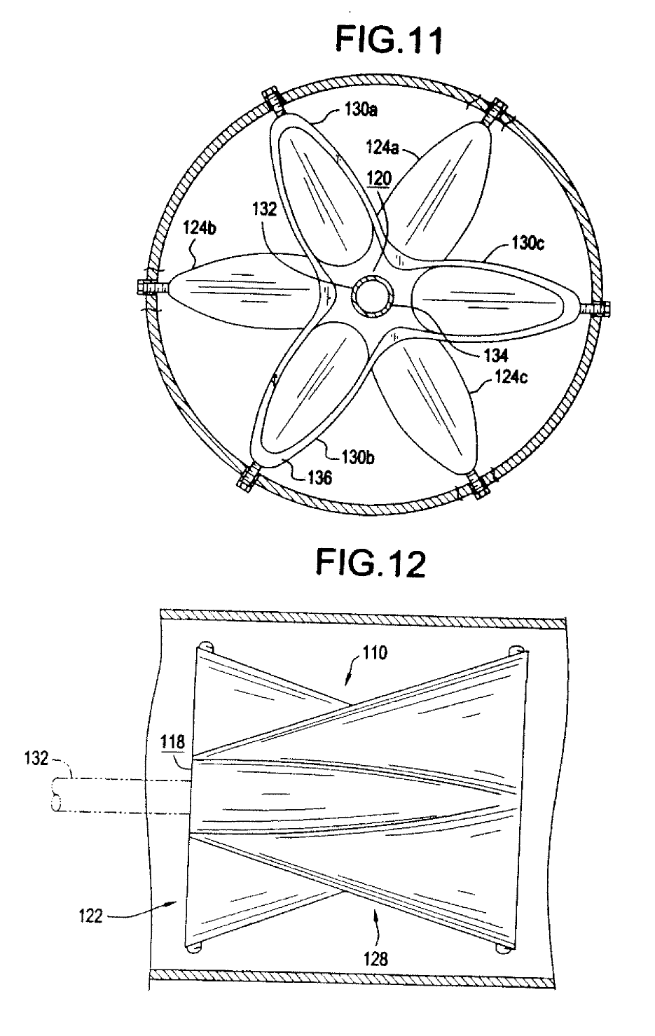

Referring now to FIG. 11, the outlet 134 of the primary additive stream injector 132 is visible from the single exit port 120. The single exit port 120 is preferably the same size, but not smaller than, the single entrance port 118. The contoured lobes 130a, 130b and 130c of the broadening region 128 are at their maximum and terminate at a trailing edge 136 which defines the outer perimeter of the single exit port 120.

Referring to FIG. 12, a side view of the extensional flow mixer 110 shows that the primary additive stream injector is positioned along the longitudinal axis of the extensional flow mixer 110. Preferably, the primary additive stream injector 132 is flush with the plane of the single entrance port 118.

The compression region 122 decreases in size in the direction of flow while the broadening region 128 increases in size in the direction of flow. It is the simultaneous converging of the compression region 122 and the diverging of the broadening region 128 that causes the increase in interfacial area between the bulk stream and any additive streams injected by the primary additive stream injector 132.

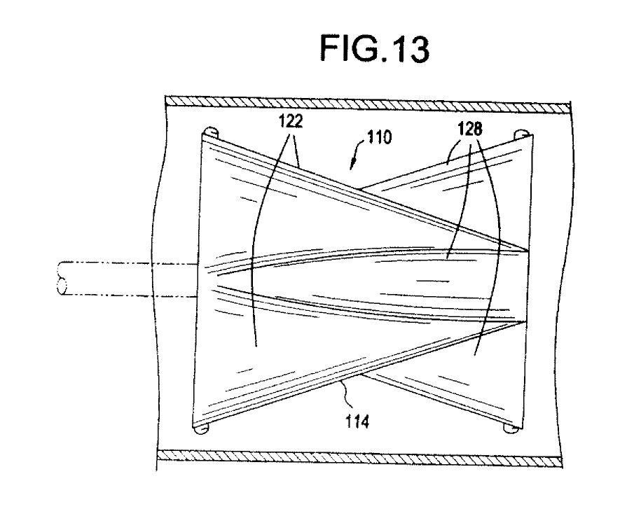

Referring now to FIG. 13, the compression region 122 is integrally formed with the broadening region 128 such that the contoured outer surface 114 does not contain any severe angular regions or step-like features that may decrease the overall mixing efficiency of the extensional flow mixer 110.

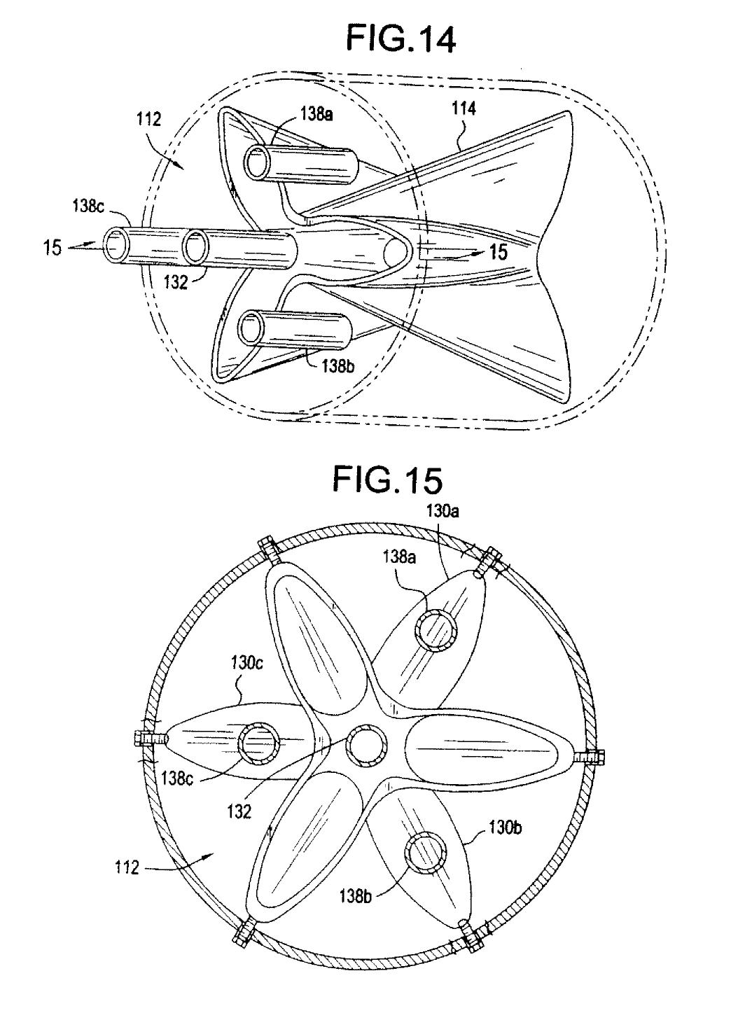

Referring now to FIG. 14, additional additive stream injectors 138a, 138b, and 138c may be oriented such that they are aimed toward the contoured outer surface 114 of the generally open and hollow flow mixer body 112.

Referring now to FIG. 15, the preferred locations of the additional additive stream injectors 138a, 138b and 138c are shown. Preferably, the additional additive stream injectors 138a, 138b and 138c are directed towards the exterior of each of the contoured lobes 130a, 130b and 130c of the broadening region 128. It is understood that fewer additional additive streams may be utilized in conjunction with the primary additive stream injector 132. It is important to note that again, there is no direct contact between neither the primary additive stream injector 132 nor the additional additive stream injectors 138a, 138b and 138c with the generally open and hollow flow mixer body 112. The absence of direct contact reduces the likelihood of additive build-up and fouling on the flow mixer body 112 during operation.

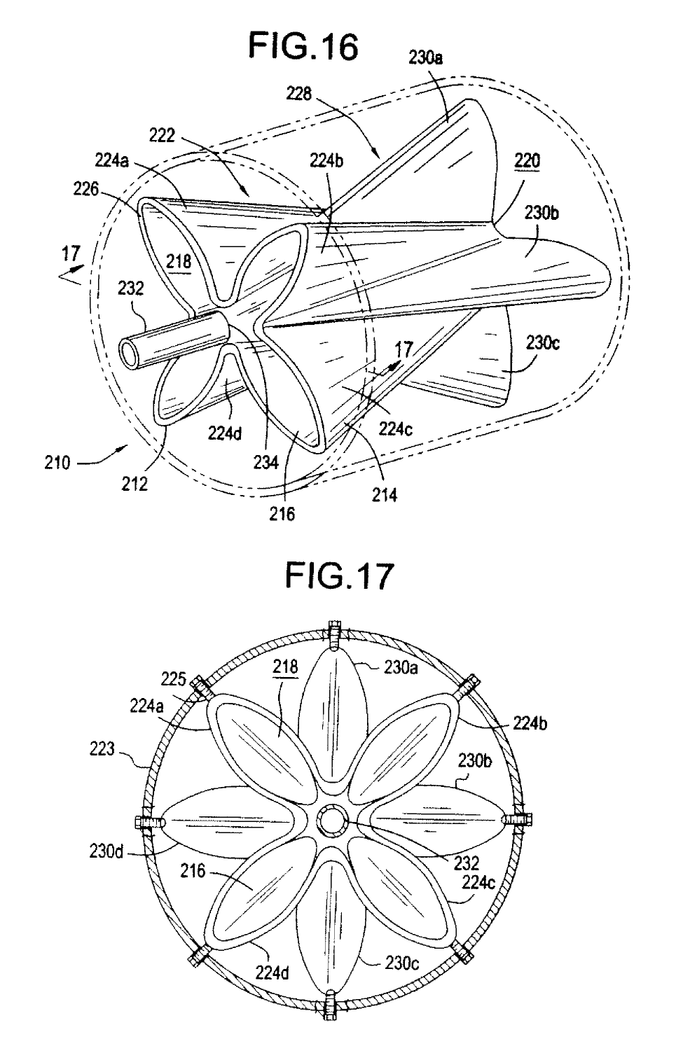

Referring now to FIG. 16, another embodiment of the present invention is shown. An extensional flow mixer, shown generally by the reference numeral 210, includes a generally open and hollow flow mixer body 212. The generally open and hollow flow mixer body 212 has a contoured outer surface 214 and a contoured inner surface 216 which follows the shape of the contoured outer surface 214.

The extensional flow mixer 210 includes a single entrance port 218 and a single exit port 220. A direction of flow is defined in moving from the single entrance port 218 to the single exit port 220.

The generally open and hollow flow mixer body 212 includes a compression region 222. The compression region 222 includes contoured lobes 224a, 224b, 224c and 224d. The contoured lobes 224a, 224b, 224c and 224d of the compression region 222 decrease in size in the direction of flow from the leading edge 226 of the single entrance port 218 to the single exit port 220. The leading edge 226 forms the outline of the single entrance port 218. The generally open and hollow flow mixer body 212 also includes a broadening region 228. The broadening region 228 similarly includes contoured lobes 230a, 230b, 230c and 230d (not shown). The contoured lobes 230a, 230b, 230c 230d in the broadening region 228 increase in size in the direction of flow when going from the single entrance port 218 to the single exit port 220. The contoured lobes 224a, 224b, 224c and 224d of the compression region 222 alternate with the contoured lobes 230a, 230b, 230c and 230d of the broadening region 228 around the contoured outer surface 214 of the generally open and hollow flow mixer body 212.

A primary additive stream injector 232 is preferably positioned at the single entrance port 218 such that the outlet 234 of the primary additive stream injector 232 is positioned at the center of and flush with the single entrance port 218.

Referring now to FIG. 17, the size and shape of the contoured lobes 224a, 224b, 224c and 224d of the compression region 222 are preferably the same as the size and shape of the contoured lobes 230a, 230b, 230c and 230d of the broadening region 228.

The primary additive stream injector 232 is preferably positioned so as to inject a primary additive stream through the interior of the generally open and hollow flow mixer body 212 without encountering any obstacles.

In operation, similarly to the other embodiments, the bulk stream flowing through the generally open and hollow flow mixer body 212 will compress in the compression region 222 and thereby compress the primary additive stream and increase its interfacial mixing area.

The bulk stream enters the single entrance port 218 and is compressed by the contoured inner surface 216 of each of the contoured lobes.

The extensional flow mixer 210 is attached to a flow conductor 223, typically a cylinder, preferably by way of struts 225, although any suitable mode of attachment is acceptable.

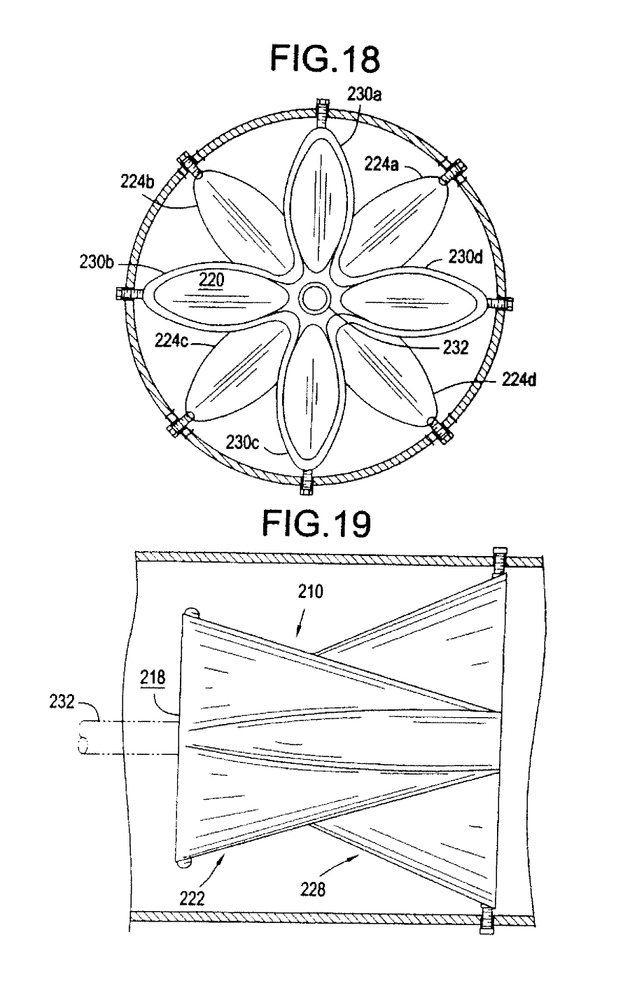

Referring now to FIG. 18, the outlet 234 of the primary additive stream injector 232 is visible from the single exit port 220. The single exit port 220 is preferably the same size, but not smaller than, the single entrance port 218. The contoured lobes 230a, 230b, 230c and 230d of the broadening region 228 are at their maximum and terminate at the trailing edge 236 which defines the outer perimeter of the single exit port 220.

Referring to FIG. 19, a side view of the extensional flow mixer 210 shows that the primary additive stream injector 232 is positioned along the longitudinal axis of the extensional flow mixer 210. Preferably, the primary additive stream injector 232 is flush with the plane of the single entrance port 218.

The compression region 222 decreases in size in the direction of flow while the broadening region 228 increases in size in the direction of flow. It is the simultaneous converging of the compression region 222 and the diverging of the broadening region 228 that causes the increase in interfacial area between the bulk stream and any additive streams injected by the primary additive stream injector 232.

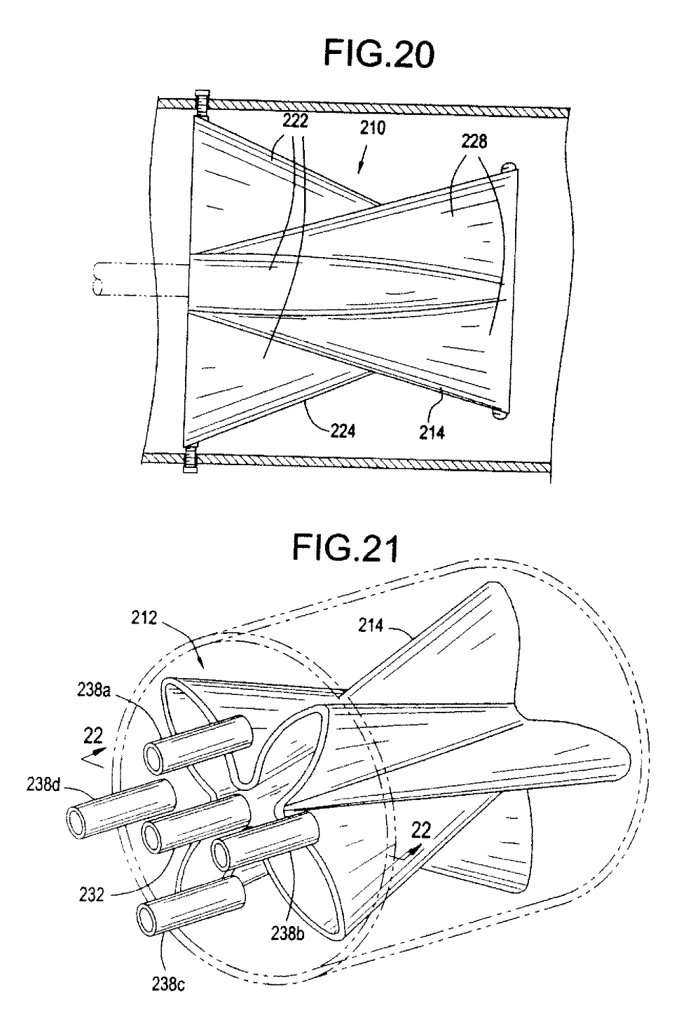

Referring now to FIG. 20, the compression region 222 is integrally formed with the broadening region 228 such that the contoured outer surface 214 does not contain any severe angular regions or step-like features that may decrease the overall mixing efficiency of the extensional flow mixer 210.

Referring now to FIG. 21, additional additive stream injectors 238a, 238b, 238c and 238d are oriented such that they are aimed toward the contoured outer surface 214 of the generally open and hollow flow mixer body 212.

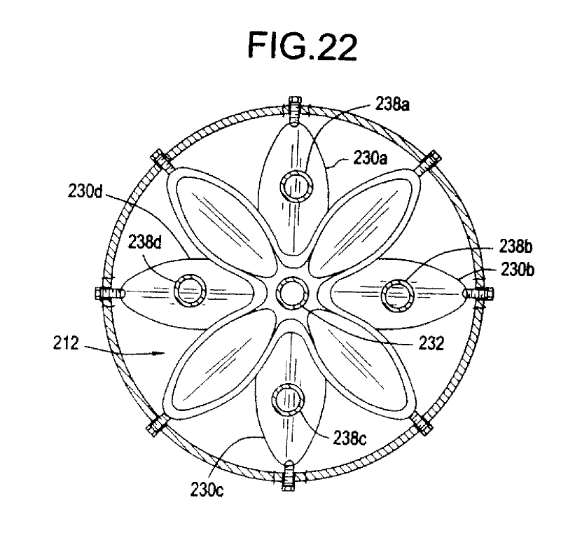

Referring now to FIG. 22, the preferred locations of the additional additive stream injectors 238a, 238b, 238c and 238d are shown. Preferably, the additional additive stream injectors 238a, 238b, 238c and 238d are directed towards the exterior of each of the contoured lobes 230a, 230b, 230c and 230d of the broadening region 228. It is understood that fewer additional additive stream injectors may be utilized in conjunction with the primary additive stream injector 232. There is no direct contact between neither the primary additive stream injector 232 nor the additional additive stream injectors 238a, 238b, 238c and 238d with the generally open and hollow flow mixer body 212. The absence of direct contact reduces the likelihood of fouling of the flow mixer during operation.

The method of the present invention is directed to mixing an additive stream with a bulk stream. It is important to note that the method contemplated by the present invention is independent of the sequence of the particular bulk stream and additive streams entering the flow mixer, and is also independent of the relative concentrations of the bulk stream with respect to the primary and additional additive streams. Additionally, many types of bulk streams and additive streams heretofore mentioned are contemplated by the present method. Particularly, additives such as catalysts, monomers, pigments, dyes, anti-oxidants, stabilizers, waxes, and modifiers are added to bulk streams including various polymer and co-polymer melts, solutions and other viscous liquids.

In accordance with the method, the generally open and hollow flow mixer is provided as heretofore described. An additive stream is injected into the single entrance port of the generally open and hollow flow mixer body. The additive stream and the bulk stream are compressed in the compression region and broadened in the broadening region to increase the interfacial area between the bulk stream and the additive stream to promote mixing of the bulk and the additive stream. The compressing and broadening steps preferably occur simultaneously.

In another aspect of the method, at least one additional additive injector is utilized along with at least one primary additive stream injector, by injecting at least one additional additive stream into the region exterior to the generally hollow flow mixer body, resulting in deformation of each of the additional additive streams in the exterior region of the generally hollow flow mixer body. The additional additive streams are shaped into curved sheets by the bulk flow field created by the exterior of the generally hollow flow mixer body. It can be appreciated that there are many combinations of primary and additive stream injectors which inject their streams both internally and externally to the generally hollow flow mixer body.

The present invention has been described in terms of the preferred embodiment, and it is recognized that equivalents, alternatives, and modifications, aside from those expressly stated, are possible and within the scope of the appending claims.

For example, it is contemplated that more than four lobes per region may be used. A multiple lobe structure having additional lobes per region may be used to mix more additives with the bulk stream. Other quantities and combinations of primary and additive stream injectors, arranged in a variety of configurations, both inside and outside the flow mixer body, are contemplated. Additionally, two extensional flow mixers may be arranged in series with a gap of approximately the diameter of the flow conductor 24 to promote additional mixing capabilities. The extensional flow mixer 10 may be used to mix, in addition to liquids, a gas with a gas, a gas with a liquid, or an immiscible liquid with a liquid. Finally, the extensional flow mixer 10 may be used in laminar, transition or turbulent flow conditions.

In another embodiment, the extensional flow mixer followed by helical type mixing elements, preferably followed by high-shear, high-pressure drop mixing elements consisting of an array of crossed bars arranged at an angle of 45° against the tube axis, can be placed between a gear pump and a screen pack, preferably also followed by a pelletizer, where a side arm extruder may feed an additive concentrate between the gear pump and the extensional flow mixer in a polymerization process, especially an ethylene polymerization process, and at a rate relative to the main process stream of 0.1 up to 30 weight percent.

High-shear and high-pressure drop mixing elements are such that they induce a shear rate that is two to three times higher than the helical type mixing elements and a pressure drop that is at least six times higher than the helical type mixing elements.

Although the invention is especially useful for mixing and blending polymers and polymer solutions, other applications include food preparations and paint blends.

For example, polymer and polymer solutions can be blended when they have similar viscosities and similar flow rates, but this mixing system is most effective when both the viscosity ratios and the flow rate ratios are not close to unity. For example, in one application, the viscosity ratios range from 300:1 to 6,100:1 for the main:additive streams and the corresponding flow ratio can range from 300:1 to 600:1 for the same two streams. In another application, the viscosity ratio can be in the range of 100:1 for the main:additive streams to 1:100 for the two streams, i.e., the additive stream can have higher or lower viscosity than the main stream. In addition, typical flow rate ratios can range from 70:30 to 98:2 by weight for the main:additive streams. Even when the extensional flow mixer is used, the best mixing is achieved when the viscosity and flow rate ratios are close to unity.

We have also discovered that problems can occur if the extensional flow mixer and the downstream mixer are not aligned correctly with each other. For example, if the additive stream is colder than the bulk stream and the extensional flow mixer outlet is aligned directly with the leading edge of the helical type mixing element, impingement on the element can cause sufficient cooling to possibly freeze, foul or precipitate polymer. We now believe that the extensional flow mixer is most effective if the outlet “flow sheet” of our invention is perpendicular in alignment to the leading edge of the first downstream element of the helical type mixing element.

We have also discovered that the extensional flow mixer together with the helical type mixing elements demonstrates much more improvement in laminar pipe flow blending systems, than in a well mixed loop reactor which had nearly continuous stirred tank reactor mixing. Thus, this invention is especially useful for the mixing of catalyst neutralization agents or additives in pipe flow after the reactor and for the mixing of two polymer melt streams, such as in sidearm extruder blending in polyethylene processes. We have also discovered that the position and shape of the injected stream before the extensional flow mixer is important to the performance of the device. Computational Fluid Dynamics studies have shown that performance is improved if the spacing between the injection nozzle and the extensional flow mixer is sufficient to allow the injection stream diameter to equilibrate with the surrounding flow, which can take place within one to five inches.

The extensional flow mixer used alone should be modified for a given application by increasing the central opening size at the point of injection so that the equilibrated diameter of the additive stream is slightly smaller than the inner walls of the extensional flow mixer device. The equilibrated additive stream diameter can be calculated based on the volumetric ratio of the main stream to that of the additive stream based on a simple mass balance.

We have discovered that the extensional flow mixer is effective for mixing fluids in which the main stream viscosity can be either higher or lower than that of the additive stream.

In another application, this mixing system can be applied to the addition of catalyst neutralization agents and antioxidants into the polyethylene solution process downstream of the reactor, where the aim is to hydrolyze the catalyst and neutralize the acid that is formed. It is not easy to measure mixing on line. Therefore, mixing can be inferred by measuring the acid at the vapor space of a tank downstream of the injection point: the higher the acid measured, the worse the mixing would be.

### EXAMPLES

The mixing system consists of a 2-inch pipe with an extensional flow mixer with two lobes and with the additive being injected coaxially in the middle of the extensional flow mixer using a half-inch pipe. Downstream of the mixer is another injector placed perpendicular to the main flow with a quarter inch to half-inch diameter pipe placed so that the tip of the pipe is in the middle of the main flow and the tip cut at 45° at a distance of one inch from the extensional flow mixer. Downstream of this injector are 12 helical type mixing elements.

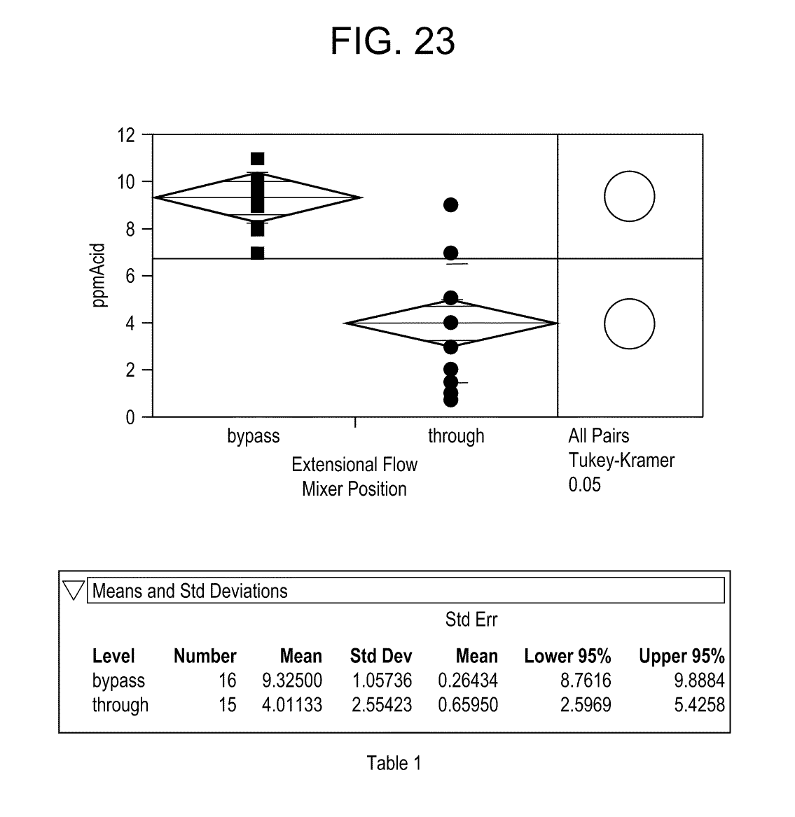

Injection is performed so that the acid neutralizing agent enters the process either upstream (bypass) or downstream (through) of the extensional flow mixer position while the system is running at steady-state conditions. A set of readings is taken and the injection is switched to the alternate position. After sufficient time is allowed for the system to reach a new steady-state, another set of readings is taken and the process is repeated for approximately one month. The readings are compared using JMP statistical analysis software, version 8 for their means and standard deviations. The results are shown in FIG. 23, where the Tukey-Kramer pairs comparison shown in Table 1 indicate that the means are statistically different and with values of approximately 9 and 4 parts per million volume, respectively, for the cases where injection is performed downstream and upstream of the extensional flow mixer.

All the methods for measuring the acid involve the use of GASTEC No. 14L detector tubes with a GASTEC GV-1000 manual gas sampling pump. The tube is hooked to the gas being sampled on one end and to the pump on the other end. The pump's handle is pulled to draw in test gas, and the changing color of the detector indicates the parts per million volume level of hydrochloric acid (HCl) in the stream. The sampling procedure is as follows: gas from the vapor stream of the downstream tank is collected in 1 or 3 liter TEDLAR gas bags. Two connections are added to the sampling station to attach gas bags. One bag is used to purge the line, and the second spot is used to pull a gas sample.

A sample is collected in the sample bag and taken to the sample hood to connect the detector tube within 10 to 15 minutes from obtaining the sample. An additional reading is taken at the sampling station while the gasbag is inflated slowly. The average of the two readings is used that are nearly identical in all cases.

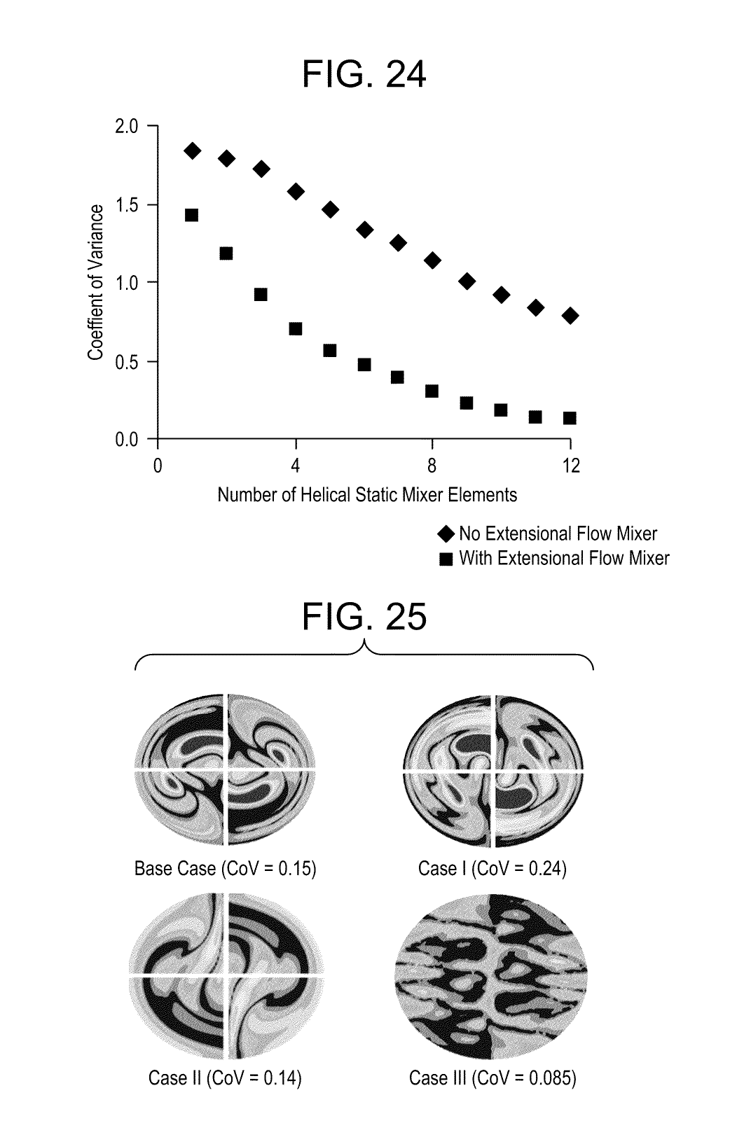

Computational Fluid Dynamics (CFD) is used to simulate a typical case of the additives injection using the base case of no extensional mixer and twelve helical type static mixer elements and one with coaxial injection, extensional mixer, and twelve helical type static mixer elements. The degree of mixing is estimated using the coefficient of variance in these two cases. The coefficient of variance is determined using the relative deviation of the local concentration from the average concentration at an axial plane at the end of each helical type mixing element. Therefore, the lower the value of the coefficient of variance, the better the degree of mixing is going to be. The results from the simulations are summarized in FIG. 24, where the coefficient of variance is plotted against the number of helical type mixing elements. The simulations predict that the coefficient of variance would drop from 0.80 to 0.15 with the addition of the extensional flow mixer upstream of the helical static mixers.

Computational Fluid Dynamics is used to simulate various cases in an attempt to obtain improved mixing with the minimal energy requirement in the form of pressure drop. Four cases are shown as examples in FIG. 25 that compare the final coefficient of variance at the exit of the mixing system that includes a coaxial injection into the extensional flow mixer followed by a series of various static mixers. Each configuration is chosen so that the overall pressure drop is approximately the same in all cases. Part of FIG. 25 is the base case, with twelve helical type mixing elements and has an estimated coefficient of variance of 0.15. Case I in FIG. 25 includes a high-shear, high-pressure drop mixing element consisting of an array of crossed bars arranged at an angle of 45° against the tube axis, followed by six helical type mixing elements and has an estimated coefficient of variance of 0.24. Case II in FIG. 25 consists of four helical type mixing elements placed downstream of the extensional mixer, followed by one high-shear, high-pressure drop mixing element consisting of an array of crossed bars arranged at an angle of 45° against the tube axis, followed by two helical type mixing elements and has an estimated coefficient of variance of 0.14. Case III in FIG. 25 consists of six helical type mixing elements placed downstream of the extensional mixer, followed by one high-shear, high-pressure drop mixing element consisting of an array of crossed bars arranged at an angle of 45° against the tube axis and has an estimated coefficient of variance of 0.085. Since all these cases have very similar pressure drops, the configuration shown in Case III is most desirable for mixing these streams.

Another application of the mixing system is in blending resins of different viscosities. The resin that is added as a smaller stream into the resin of the main flow can be either more or less viscous than the main flow resin or even have the same viscosity as the main flow resin. Computational Fluid Dynamics simulations indicate that the mixing system comprising a coaxial injection through the extensional flow mixer followed by helical type mixing elements with additional high-shear, high-pressure drop mixing elements consisting of an array of crossed bars arranged at an angle of 45° against the tube axis is superior to just using a tangential type injection upstream of helical type mixing elements when the two systems were compared at similar energy requirements in the form of pressure drop. In addition, mixing is expected to be better if the mixing system comprises a coaxial injection upstream of the extensional flow mixer followed by a one pipe diameter gap followed by helical type mixing elements as compared to a system comprising coaxial injection upstream of the extensional flow mixer followed by a one pipe diameter gap followed by high-shear, high-pressure drop mixing elements consisting of an array of crossed bars arranged at an angle of 45° against the tube axis if the two mixing systems are compared at the same pressure drop requirements.

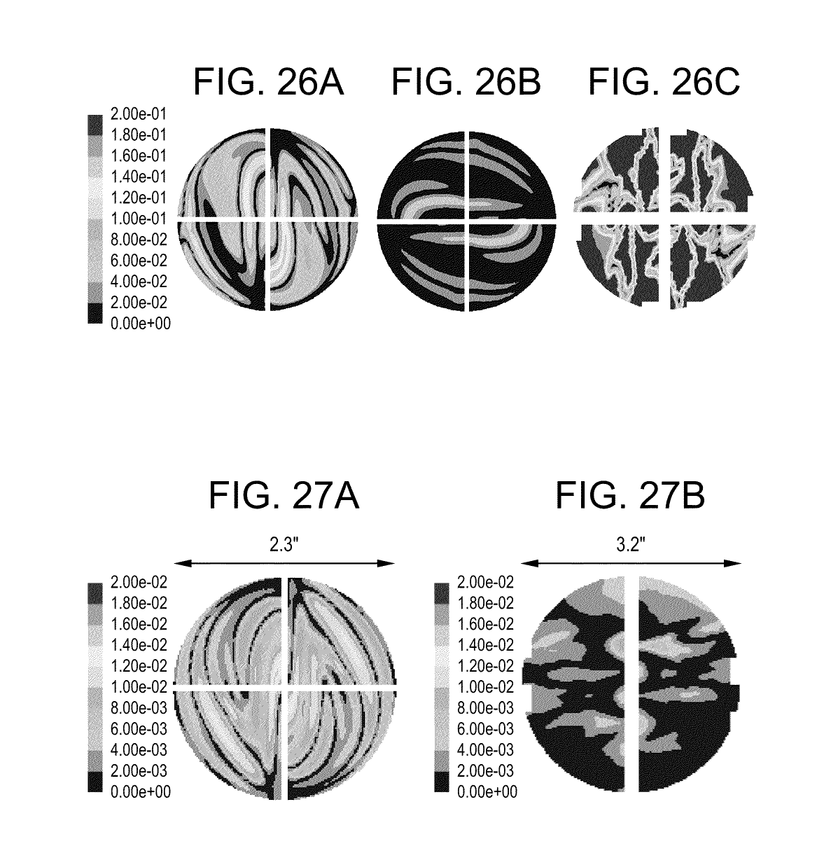

FIG. 26 presents the coefficient of variance for the blending of two resins with the main flow resin having a viscosity of approximately 30,500 poise and the side stream resin having a viscosity of approximately 20,000 poise. The flow ratio of the side stream to the main stream is 8.3 in terms of mass. Three cases are compared in FIG. 26, all showing the degree of mixing at the same pressure drop, and the coefficient of variance is shown at the end of each mixing system. Case (a) in FIG. 26 comprises a mixing system consisting of a tangential injection and 14 helical type mixing elements and exhibits a coefficient of variance of 0.047. Case (b) in FIG. 26 comprises a coaxial injection upstream of the extensional flow mixer, followed by one pipe diameter gap, followed by thirteen helical type mixing elements and has a coefficient of variance of 0.017. Case (c) in FIG. 26 comprises a mixing system consisting of a coaxial injection upstream of the extensional flow mixer, followed by one pipe diameter gap, followed by two high-shear, high-pressure drop mixing elements consisting of an array of crossed bars arranged at an angle of 45° against the tube axis and has a coefficient of variance of 0.23. These simulations show that a coaxial injection upstream of the extensional flow mixer improves mixing when that setup is placed upstream of helical type mixing elements, with the number of helical type mixing elements adjusted so that the two mixing systems exhibit approximately the same pressure drop. In addition, high-shear, high-pressure drop mixing elements consisting of an array of crossed bars arranged at an angle of 45° against the tube axis are not as efficient in mixing resins of different viscosities as are helical type mixing elements when they are compared at similar pressure drops.

Another set of simulations is performed comparing a case of blending two resins with the main stream viscosity stream viscosity at 5,000 poise and the small stream viscosity at 20,000 poise and the amount of small stream entering at 7.5 weight percent of the total flow. Two cases are compared for degree of mixing and the simulations are shown in FIG. 27. Case (a) in FIG. 27 comprises a mixing system that includes a coaxial injection upstream of the extensional flow mixer followed by a one-pipe diameter gap then followed by eighteen helical type mixing elements, into a conductor of 2.3 inches inside diameter. Case (b) in FIG. 27comprises a mixing system that includes a coaxial injection upstream of the extensional flow mixer followed by a one-pipe diameter gap then followed by nine helical type mixing elements, into a conductor of 2.3 inches inside diameter; a diameter adaptor to increase the conductor diameter from 2.3 to 3.2 inches inside diameter, followed by three high-shear, high-pressure drop mixing elements consisting of an array of crossed bars arranged at an angle of 45° against the tube axis and each element rotated at 90° to each other inside the 3.2 inch conductor. Case (a) in FIG. 27 has a coefficient of variance of 0.0063 at the end of the mixing system and an estimated pressure drop of 91 pounds force per square inch. Case (b) in FIG. 27 has a coefficient of variance of 0.0019 at the end of the mixing system and an estimated pressure drop of 80 pounds force per square inch.

This example is also tested with the same setup as described above. The polymer is taken through an underwater pelletizer and the resulting polymer pellets could be tested using various analytical techniques. At the end of the mixing setup there is a diverter valve that could be opened and the polymer could be allowed to flow out of the system as a continuous cylindrical “rope”. For flow visualization purposes, approximately twenty weight percent of the pellets in the side stream are replaced with pellets that are compounded with one weight percent carbon black. Therefore, as the two streams are blended, one could observe the striations and estimate the extent of mixing. One way to observe the mixing is to obtain a thin sliver of the polymer cylindrical “rope” cut perpendicular to the axial direction and cut along the axis of the pipe and place the pieces under a light.

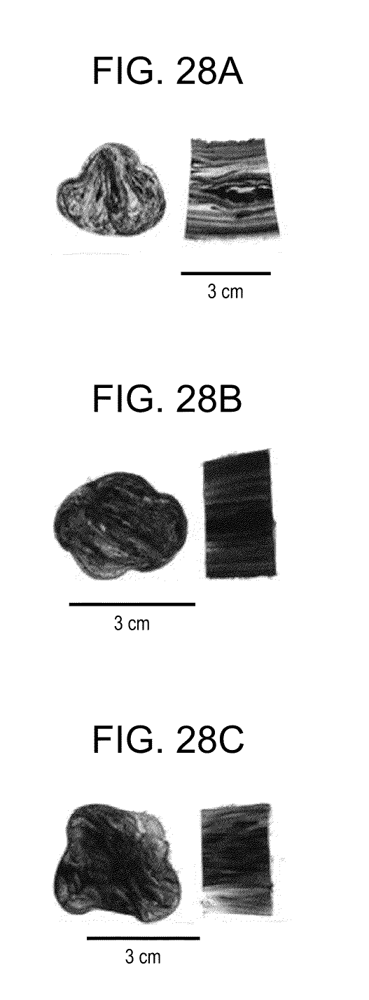

FIG. 28 compares three cases for the resins described above and three configurations: (a) tangential injection of the side stream through eighteen helical type mixing elements placed inside a conductor of 2.3 inches in inside diameter; (b) coaxial injection of the side stream placed upstream of the extensional flow mixer followed by 2.3 inches of gap followed by eighteen helical type mixing elements placed inside a conductor of 2.3 inches in inside diameter; and (c) coaxial injection of the side stream placed upstream of the extensional flow mixer followed by 2.3 inches of gap followed by nine helical type mixing elements placed inside a conductor of 2.3 inches in inside diameter, followed by an adaptor to increase the conductor diameter from 2.3 to 3.2 inches inside diameter, followed by three high-shear, high-pressure drop mixing elements consisting of an array of crossed bars arranged at an angle of 45° against the tube axis and each element rotated at 90° to each other inside the 3.2 inch conductor. FIG. 28 shows the axial and longitudinal striations representing the degree of mixing for the three cases described above. In FIG. 28, the domains that contain either the black resin (secondary stream) or the white resin (primary stream) are smaller for case (b) as compared to case (a). In addition, those domains are more evenly distributed along the whole diameter of the conductor for case (c) as compared to case (b). Therefore, case (c) in FIG. 28 offers marginal improvement over case (b). The estimated pressure drop for case (a) FIG. 28 is 86.5 pounds force per square inch, for case (b) FIG. 28 the pressure drop is estimated at 91 pounds force per square inch, and the pressure drop for case (c) FIG. 28 is estimated at 80 pounds force per square inch.

We claim:

1. A mixing system comprising at least one extensional flow mixer comprising:
a generally open and hollow body having a contoured outer surface and having:
a single entrance port and a single exit port;
a means for compressing a bulk stream flowing through the generally open and hollow body in a direction of flow and at least one injected additive stream introduced at the single entrance port in the direction of flow; and
a means for broadening the bulk stream and the at least one injected additive stream such that an interfacial area between the bulk stream and the at least one injected additive stream is increased as the bulk stream and the at least one injected additive stream flow through the generally open and hollow body in the direction of flow to promote mixing of the bulk stream and the at least one injected additive stream,
a flow conductor having an axis and having a generally open and hollow flow mixer body secured therein; and
a primary additive stream injector positioned at the entrance port of the generally open and hollow flow mixer body, wherein the primary additive stream injector injects an additive stream into the interior of the flow mixer in the direction of flow when the bulk stream is flowing through the generally open and hollow flow mixer body to allow compression and broadening of the bulk stream and the additive stream together to facilitate mixing of the bulk stream and the primary additive stream at an exit of the extensional flow mixer,
wherein the extensional flow mixer is followed by at least one of helical static mixing elements that is at least one half flow conductor diameter downstream of the exit of the extensional flow mixer.

2. The mixing system of claim 1 wherein the means for compressing and the means for broadening each includes a plurality of contoured lobes, each lobe having a substantially contoured surface and wherein the plurality of contoured lobes in the means for compressing decrease in size in the direction of flow and the plurality of contoured lobes in the means for broadening increase in size in the direction of flow.

3. The mixing system of claim 1 wherein the means for compressing lie in a compression plane and the means for broadening lie in a broadening plane perpendicular to the compression plane.

4. The mixing system of claim 1 wherein the means for compressing decreases in size along the compression plane in the direction of flow and the means for broadening simultaneously increases in size along the broadening plane in the direction of flow.

5. The mixing system of claim 1 wherein the helical mixing element is not more than four flow conductor diameters downstream.

6. The mixing system of claim 1 further comprising of at least one of high-shear, high-pressure drop static mixing elements comprising an array of crossed bars arranged at an angle of 45° against the axis and arranged in such a way, that consecutive elements are rotated by 90° around the axis, placed downstream of the helical mixing elements.

7. The mixing system of claim 1 wherein the primary additive stream injector is positioned at a center of the entrance port.

8. The mixing system of claim 1 wherein the primary additive stream injector is positioned along a longitudinal axis of the generally hollow flow mixer body.

9. The mixing system of claim 8 wherein the additive stream injector is further positioned at a center of the single entrance port.

10. The mixing system of claim 1 wherein the bulk stream received by the single entrance port includes at least one of a polymer and a polymer solution.

11. The mixing system of claim 1 wherein the additive stream received by the single entrance port includes at least one of a monomer and a monomer solution.

12. The mixing system of claim 1 wherein the additive stream received by the single entrance port includes at least one of an additive or additive in solution.

13. The mixing system of claim 12 wherein the additive stream received by the single entrance port is selected from a group consisting of antioxidants, acid scavengers, catalyst kill agents and solutions thereof.

14. The mixing system of claim 11 wherein the monomer solution is ethylene dissolved in solvent.

15. The mixing system of claim 1 wherein the lobes of the compression region meet at a constricted central entrance portion and the lobes of the broadening region meet at a constricted central exit portion.

16. The mixing system of claim 1 wherein the exit of the extensional flow mixer is perpendicular to a leading edge of the helical type mixing element.
